(19) United States
(12) Patent Application Publication
(10) Pub. No.: US 2008/0085503 A1
(43) Pub. Date: Apr. 10, 2008

(54) Instructional system and method

(75) Inventor: Will Handzel, Beverly Hills, MI (US)

Correspondence Address: ARENT FOX LLP, 1050 CONNECTICUT AVENUE, N.W., SUITE 400, WASHINGTON, DC, 20036, US

(73) Assignee: WHABA

(21) Appl. No.: 11/898,635

(22) Filed: Sep. 13, 2007

Related U.S. Application Data
(60) Provisional application No. 60/844,381, filed on Sep. 14, 2006.
(60) Provisional application No. 60/929,819, filed on Jul. 13, 2007.

(51) Int. Cl. G09B 25/00

(52) U.S. Cl. 434/369

(57) ABSTRACT

A system and method for creating multimedia templated instructional sequences for easy assembly or installation of consumer or other products. The assembly or installation process is divided into separate sequential discrete steps. Each discrete step in the overall process is described using multimedia visual and textual information, so that a title for the activity is created, the tools for performing the activity are identified, the location context where the activity should be performed is documented, the activity is described in detail using three steps or less, and any additional activity, such as helpful hints, is also documented. The visual/textual description for all discrete steps in the overall process is assembled into a user-friendly instructional template.

### RELATED APPLICATIONS

This application claims the benefit of U.S. Provisional Application Ser. No. 60/844,381 filed Sep. 14, 2006, titled “Instructional System and Method,” and U.S. Provisional Application Ser. No. 60/929,819 filed Jul. 13, 2007, titled “Instructional System and Method.” Each of the above-mentioned patent applications is incorporated in its entirety by reference herein.

### BACKGROUND OF THE INVENTION

1. Field of the Invention

The present invention relates to the field of instructional information for products and, in particular, to methods and systems for providing instructional information that use a templated multimedia based approach.

2. Background of the Technology

There remains a problem in the prior art in that non-regular users of products, such as novice individuals desiring to install automotive or other parts and/or assemble devices, need assistance with understanding how to install and/or assemble such products. In the prior art, attempts to provide such instructions have primarily focused on providing written instructions, sometimes with minimal diagrams or pictures. However, these prior art attempts often leave users with too little understanding of the appropriate ways to install/assemble products. Further, it appears that users often prefer not to use written instructions when installing or otherwise using such products.

There are many books, videos and other forms of educational and instructional media formats available for such users. However, most such products require a significant time investment by the user to read and master the material being presented, and yet these materials often skip over important details, forcing the user to “fill-in-the-blanks” in a frustrating failure-prone process.

These and further problems of the prior art are also often related to the process of development of instructions. Typically, an engineering organization or other entity developing instructions for a product spends the vast majority of its time developing and testing the product, working with the manufacturers and sellers, and marketing and testing buyers to refine the product, prepare packaging, and ship the product. Many engineering organizations do not assign the appropriate resources and time to create thorough and easy-to-use instructions. As a result, a minimal amount of time is typically available for producing instructions for installation/assembly of the product, and this time is usually expended at the very end of the product development lifecycle, when the developer is rushing to complete the product's release. As a result, many instructions that are developed often make assumptions of knowledge or capability of the user and skip details the end user will need to be successful when assembling, installing and/or integrating the product.

### SUMMARY OF THE INVENTION

The present invention overcomes the above-identified problems of the prior art, as well as others, by providing methods and systems for instructing users regarding the installation and/or assembly of products via the use of a templated, multimedia-based approach to instruction.

Among other things, the methods and systems of embodiments of the present invention provide easy and enjoyable ways to create and use instructions that can increase sales and customer satisfaction of a product, such as a specific component or system requiring installation, assembly and/or integration. In some embodiments, a cartoon character or other friendly mechanism conveys instructional information using intuitive images and minimal wording, helping to minimize frustration and maximize success. Such a cartoon character or other mechanism may also be extended throughout the product lifecycle or other product applications, such as for use in marketing and leveraging support of sales of instructions, integration kits, apparel, equipment, and other merchandising opportunities.

While the novice do-it-yourself (DIY) user obviously needs considerable assistance to successfully complete a previously unknown process on the first try, for the professional, such as a “trained mechanic,” the instructional method and system of the present invention is also useful. In market research, many mechanics, from novice to expert, have shown a need for the instructional system of the present invention to help guide them through the “roadblocks” of unfamiliar installations and product integration.

The instructional method and system of the present invention are the result of careful research, testing and hard-nosed improvements. The method and system are based on the following tenets: 1) people often do not read instructions until they hit a “roadblock” in a process—then they grudgingly refer to the instructions; 2) instructions with lots of words and few images are typically found nearly useless; 3) most people targeted for embodiments of the present invention will probably not perform the process being attempted more than once or twice in their lives; 4) the knowledge of how to manipulate a specific tool or component cannot be assumed—and is easily showcased with the method and system of the present invention; 5) if the instructions are not at least minimally enjoyable to use—if not fun—they are generally much less valuable; and 6) generating instructions can be broken down using a formulaic approach (through, for example, a software-based instructional method and system).

Features of exemplary embodiments of the multimedia instructional method and system of the present invention include explaining a process with multimedia support. According to one embodiment, the reading required to impart knowledge is minimized (e.g., by focusing on using approximately 5 words or less per instruction line). According to one embodiment of the present invention, a combination of multimedia information, such as photographs, video, and/or illustrations is used to graphically demonstrate how to carry out each step in a process. Further, one embodiment of the present invention uses a templated, efficient layout to allow the user to easily find specific information on each step, such as when a “roadblock” or problem is encountered.

According to one embodiment of the present invention, the user has the ability to learn at the user's own pace and preferred order, due to the feature of the present invention of finding and selecting discrete process steps quickly and easily, and providing the option of moving from one step to another, as well as skipping and/or repeating steps. In one embodiment, the present invention is portable, does not require complicated technology, and is user-friendly.

The use of a cartoon character or similar feature in one embodiment, reduces the resistance to tackling complicated written instructions, which is commonly experienced by users when using learning tools of the prior art. Yet another feature of the present invention, according to one embodiment, is that each templated instruction, once completed in a first language, may be easily converted for use in other languages. A further feature of the present invention, according to one embodiment, allows the simplified and quick creation of easy to understand instructions.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 shows an exemplary flow diagram of various functions performed in creating an instructional presentation, in accordance with an embodiment of the present invention;

FIG. 2 shows various features of an exemplary computer system for use in conjunction with an embodiment of the present invention;

FIG. 3 presents an exemplary system diagram of various hardware components and other features, in accordance with an embodiment of the present invention;

FIG. 4 contains another representative system diagram of various components usable with embodiments of the present invention, as well as the indicated representative functionality therefor; and

FIGS. 5-7 show exemplary graphical user interface (GUI) screens and further information relating thereto, in accordance with an embodiment of the present invention.

### DETAILED DESCRIPTION

The present invention overcomes the above identified problems of the prior art, as well as others, by providing multimedia instructional methods and systems the user ‘looks at’ to perform discrete process steps in assembling and/or installing products, the methods and systems of some embodiments including a templated, multimedia-based approach to instruction.

In one embodiment of the present invention, each instructional page includes a main image (and/or other multimedia information), color keyed icons showing what tools or other implements should be used with the instructional activity involved in the main image/multimedia information, a color keyed icon showing where the task is to be performed on the overall assembly, as well as other images to aid in understanding the instructional activity of the main image/multimedia information and the relationship of this information to the overall assembly and/or installation or other procedure being performed. In one embodiment, the description of each discrete step is reduced to a minimum, e.g., is limited to five words or less, to the extent possible.

Another aspect of embodiments of the present invention relates to a method and system for creating instructions. In one exemplary embodiment, the method and system include a templated procedure for developing an instructional activity, such as component installation in a vehicle. A first element of the method and system for creating instructions is the use of a template for an instructional activity layout that includes: 1) a crisp, well-lit photograph or other image relating to the instructional activity being taught, with the particular work highlighted (e.g., via a circle or other focusing mechanism) and/or located in the middle of the templated layout, as an option; 2) a short title (e.g., five words or less); 3) a cartoon figure or other assistant-like image or other mechanism, for example, to make the instructions more “user friendly”; 4) icons of any tool needed with the activity and, optionally, a cartoon image or other representation of the tool to help with understanding and using the tool (e.g., a box and wrench with size and function indicated); and 5) a work location icon, such as a simplified icon of the vehicle to help the user visually orient themselves where the task needs to occur.

Among other things, the use of a cartoon character or other assistant-like image is intended to reduce the “dryness” of the presentation, so as to make the presentation more user-friendly. This approach is particularly useful for DIY and/or hobbyists who do not regularly or professionally perform the functions described.

Another exemplary aspect of embodiments of the templated procedure is the inclusion of a description that includes no more than three steps for any activity, with each step including no more than five words, to the extent possible. In addition, a “helpful hint,” such as a helpful comment for carrying out the activity being described, is optionally provided. Examples of such a “helpful hint” include “put a rag here” or “use a rubber band there.”

The instructional aspect of the present invention may be implemented in many forms, such as in paper/printed form, or on a still or moving image, such as via a display on a terminal (e.g., a screen for a minicomputer, a microcomputer, a mainframe computer, a television screen or other display, a telephone device, or a hand-held device, such as a personal digital assistant (PDA)).

In one embodiment, the instructions are deliverable via electronic or other media, such as a digital video disk (DVD), compact disk-read only memory (CD-ROM), floppy disk, optical disk, or email or other electronic or other transmission. For example, an installation procedure developed in accordance with the present invention may be stored on a CD-ROM or DVD and included with a part to be sold or installed, or the CD-ROM or DVD may be separately orderable to be used with a part to be sold or installed. The instructions may also be retrievable via a network, such as from a server accessed via the Internet. For example, product instructions may be accessible by product via a website for the selling company, after the user has purchased the product.

In various embodiments of the present invention, each of the templated features may be fixed or may be interactively viewable and/or otherwise usable. For example, for an implementation for use via a terminal, each of the developed features (e.g., the tool to be used with the activity) is separately viewable, may be added to or removed from the template by the user, and additional discussion and/or other information may be accessible for the feature (e.g., a cross-reference to full tool description and discussion of its use is accessible from the template that contains the main activity image). In addition, common “troubleshooting” or other assistance may be provided (e.g., a button to select additional instructions if “I can't get the exhaust pipe connected” or other common problems are encountered).

Interactively viewable information can also include such information as video clips and/or other multimedia information. In some embodiments, a small window is included with the other information, in which a video clip repeatedly plays or in which a user may select to play the video clip.

Example embodiments will now be described in conjunction with the following figures.

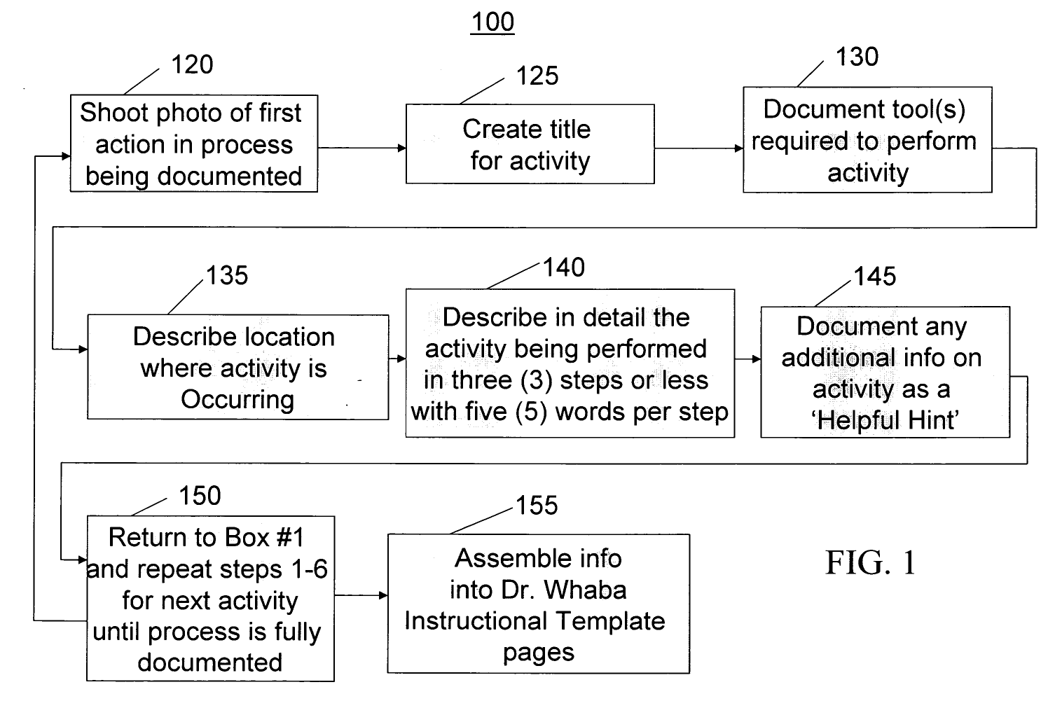

FIG. 1 shows an exemplary flow diagram 100 of various functions performed in creating an instructional activity, in accordance with a method and system for an embodiment of the present invention. In accordance with one embodiment, the overall process for which an instructional sequence is being provided must first be broken down or divided into discrete activities or steps. As shown in FIG. 1, the process begins with taking a photograph or obtaining other multimedia image or recording 120 of a first action or discrete step in the process that is being documented. In one embodiment, it is helpful to start with most basic activity, (e.g., with opening the box in which the product was shipped), and to proceed with each subsequent discrete step in the procedure. For the photograph or other multimedia recordation, a tripod mount camera or other orienting or stabilizing feature may be used, for example, to allow high f-stop (at least 5 f-stop) images. Optionally, a “Light Painter” or other highlighting feature may be used to highlight a particular area being documented in the photograph or other multimedia presentation. In addition, images of hands, arrows, pointers or other features in each photograph or other recording may be used to highlight or otherwise assist with showing certain activity being performed.

In one embodiment, each of the remaining elements of the instructions of the process being documented typically revolves around or relates to the photograph or other multimedia information recorded 120. The multimedia information may be initially embedded or otherwise related to the template.

Next, a title for the activity/discrete step recorded is created 125. in one embodiment, the title should be as short and as descriptive as possible, e.g., it should be created using five words or less and using action words to describe the activity/discrete process step (e.g., cut, tighten, remove).

One or more tools relating to the activity photographed are then identified 130. For example, a graphical representation of an identified relevant tool may be superimposed on or located in proximity to the main photograph or other multimedia information recorded.

Next, a graphical representation in the form of an icon is placed on the template showing the location where the activity or discrete step identified should be performed 135. For example, a simplified version of the overall front three-quarter image of a vehicle may be shown with a brightly colored indicator (also referred to interchangeably herein as a “locating orb”) situated at the appropriate location on the vehicle so the user can identify the location where the specific activity relating to the process of installing the specific part, or the work to be executed, should be performed. In other embodiments, rather than presenting an image of the general procedural context, the context may be selectably viewable, such as via a pulldown menu or selection button. As an alternative to an image, a textual description of such context may be provided. A “location” is described in relationship to where an activity is occurring, for example, with words used to explain the location on the base product (e.g., vehicle, house, equipment located under hood of engine compartment, passenger side).

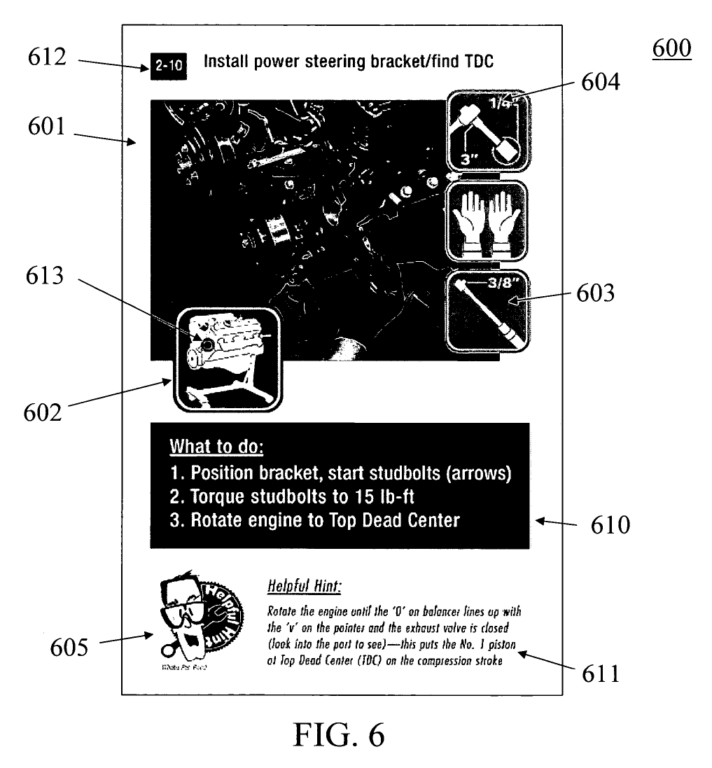

Next, a breakdown of the activity/discrete process step being described is made 140. For example, for the activity shown in FIG. 6 and described further below, the elements of the activity are identified (e.g., “1. Loosen clamp nut on battery, 2. Wiggle clamp back and forth; 3. Remove battery cable from stud”). In accordance with one embodiment, it may be helpful to describe the activity/discrete process step in as few steps as possible (e.g., three or fewer steps), to ensure that the user's attention is continuously focused on the activity, to the extent possible, without being diverted elsewhere. If not possible or reasonable to describe the activity/discrete process step in three steps or less, the activity may be split by returning, e.g., to depicting a multimedia image, of a sub-activity/discrete step that may be described in three steps or less. In accordance with one embodiment, it may be preferable to use sentences of five words or less, to the extent possible.

Identifying the elements of the activity being described may also include documenting tool actions for performing the activity, such as listing tool(s) and size(s) required (e.g., open end wrench, 13 mm). Optionally, the tool information may be used to create a representative Tool Icon that is placed on the template page.

Referring again to FIG. 1, as part of identifying the elements of the activity, additional helpful, but not absolutely necessary, elements may be identified 145, such as those that may lend themselves to becoming “Helpful Hints.” For example, “wrap cable end in a rag and push down next to the battery to help ensure that the cable does not short between the positive and negative terminals” may be transformable into a “Helpful Hint” to be added to the template. In one embodiment, sentences of 10 words or less, to the extent possible, may be used to describe helpful hints relating to the technology. Helpful hints provide additional value to the user regarding, for example, safety, ease-of-use, integration, application, performance and other issues.

The steps described above are repeated 150 for each additional activity or discrete process step until the overall process being described is fully documented. Thus, for each activity or discrete process step in the overall process, relevant multimedia information (e.g., shoot a photograph) or depiction is obtained 120, a title is created 125, the tool(s) required for the activity are described 130, the location of performing the activity is described 135, the activity is described in three steps or less 140, and helpful hints (if any) are documented 145.

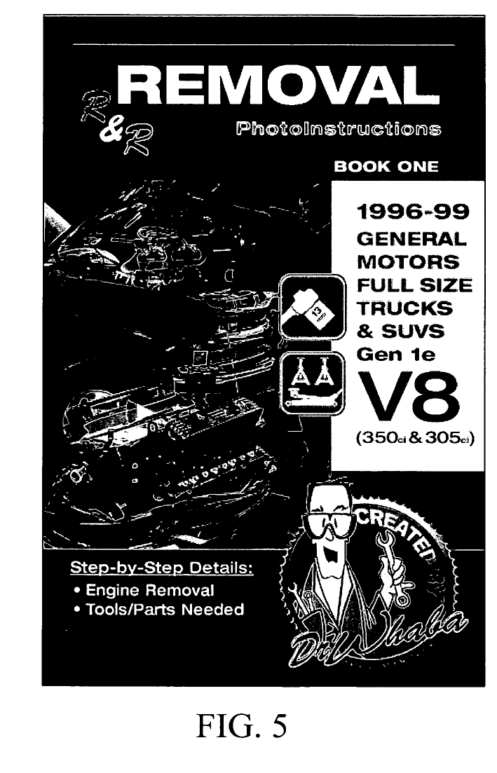

Upon completion of the multimedia documentation of all activities/discrete steps in the overall process 150, the documented process is assembled into multimedia instructional pages or template 155. In accordance with one embodiment, the assembled information is checked for factual correctness and sequencing. Optionally, photographs and/or other multimedia images or information for an instruction cover page, such as the one shown in FIG. 5 and described more fully below, are created. Also optionally, tabbed section separators, back page, and any other appropriate sections may also be created.

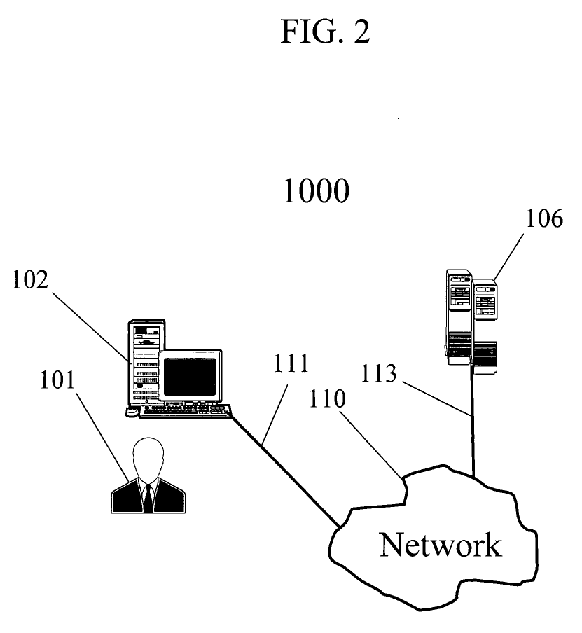

FIG. 2 shows various features of an example computer system 100 for use in conjunction with an embodiment of the present invention. As shown in FIG. 2, the computer system 1000 is used by a user 101 to access and/or otherwise use data, such as images and/or other multimedia information from a server or other network device 106 via a terminal 102, network (e.g., the Internet) 110, and couplings 111, 113. The terminal 102 may comprise, for example, a personal computer (PC), minicomputer, mainframe computer, microcomputer, telephone device, personal digital assistant (PDA), or other device having a processor and input capability. The server 106 may comprise, for example, a PC, minicomputer, mainframe computer, microcomputer, or other device having a processor and a repository for data or that is capable of accessing a repository of data. Couplings 111, 112 may include wired, wireless, or fiberoptic links.

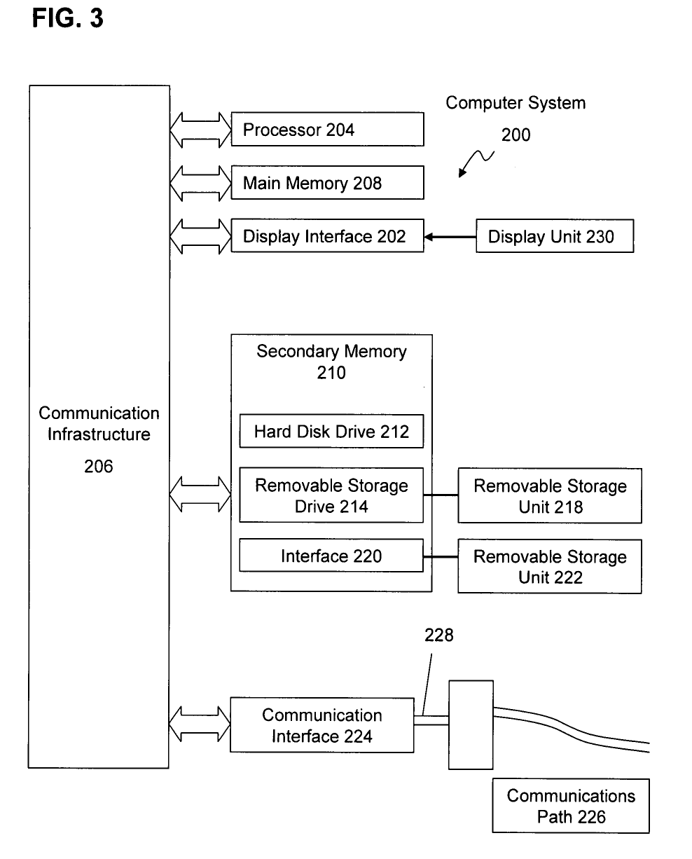

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 3.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

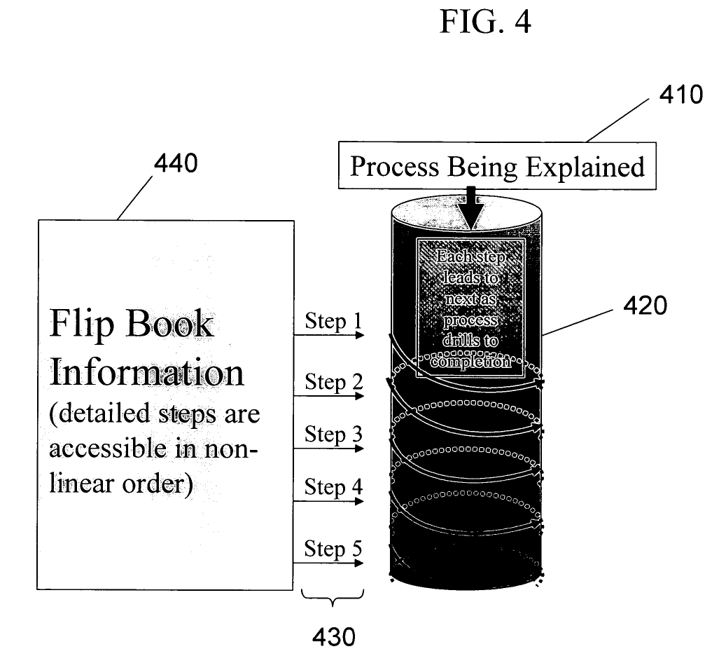

Referring now to FIG. 4, therein illustrated is a representative system diagram of various components usable with embodiments of the present invention, as well as the indicated representative functionality therefor. The process being explained 410 is divided into discrete activities or steps 430, with each step sequentially leading to the next until the process is completed 420. At each step 430, still photographs (and/or other multimedia information and/or images), icons, and minimal text may be used to allow the user to quickly visually understand how to perform the activity/step being explained.

In accordance with one embodiment, the user can easily navigate among the cross-referenced steps and their respective numbers 430, which may be used in one medium, e.g., a Flip Book 440, to navigate through the information at the user's own pace, thereby minimizing the effort required to gain knowledge of the process.

In one embodiment, the Flip Book 440 may be a printed product-specific instructional booklet, which may be professionally printed, full-color and, e.g., spiral bound. In accordance with one embodiment, each page of the Flip Book 440 may be templated to contain the appropriate amount of information in easily recognizable areas of each page. Each step 430 (or a group of related steps) may be separated by a tab section from the remaining steps. In accordance with one embodiment, each step 430 in the Flip Book may be explained, e.g., visually, with minimum written description, in accordance with the process described in connection with FIG. 1 above.

In one embodiment of the present invention the process described in connection with FIG. 1 above may be used to create instructional sequences, such as a Flip Book, for example, for any process for which and instructional sequence is needed. For example, required information and images for each step of the process may be prompted by the method and system of the present invention, in accordance with one embodiment. Instructions may show the activity to be performed, for example, via a templated layout of print photographs (and/or other multimedia information and/or images), minimal text, and location/tool icons. This approach may be usable to guide the assembly of an instructional sequence, such as a Flip Book of images and/or information, for any desired process.

FIG. 5 shows an exemplary title or cover page, in accordance with an embodiment of the present invention. As shown in FIG. 5, the cover page is designed to be easily recognizable, with a common look, color, fonts for each section, and character(s), if any.

FIG. 6 shows an exemplary instruction activity, in accordance with an embodiment of the present invention. As shown in FIG. 6, the main image 601 of the instructional page 600 shows “step 2-10” 612 of a vehicle part installation procedure titled “Install power steering bracket/find Top Dead Center (TDC).” A work location icon image 602 shows an overview of the product involved (in this example, an engine), with the location of the activity or step to be performed indicated with an indicator, e.g., a circle, 613, also referred to interchangeably herein as “a location orb.” An expanded view of the location orb (not shown) may be viewed on the main image 601. Other images may be indicative of tool(s) being used 603, 604, and an iconic cartoon figure or other assistant-like image 605 may be included. A minimally descriptive box of instructions 610 (preferably explaining the performance of the activity or discrete step in three steps or less) and a “Helpful Hint” 611, which may represent additional helpful information to maximize success, may also be provided. In this case, step 2-10 of an overall procedure for installing an engine in a specific vehicle is shown, which is part of a 150-step overall procedure. Up to 150 or more corresponding pages of a Flip Book of images may also be provided as or as part of these instructions. The Flip Book may be used to prepare for the installation by understanding the entire process prior to beginning work or, for example, may be consulted only if the user runs into difficulty.

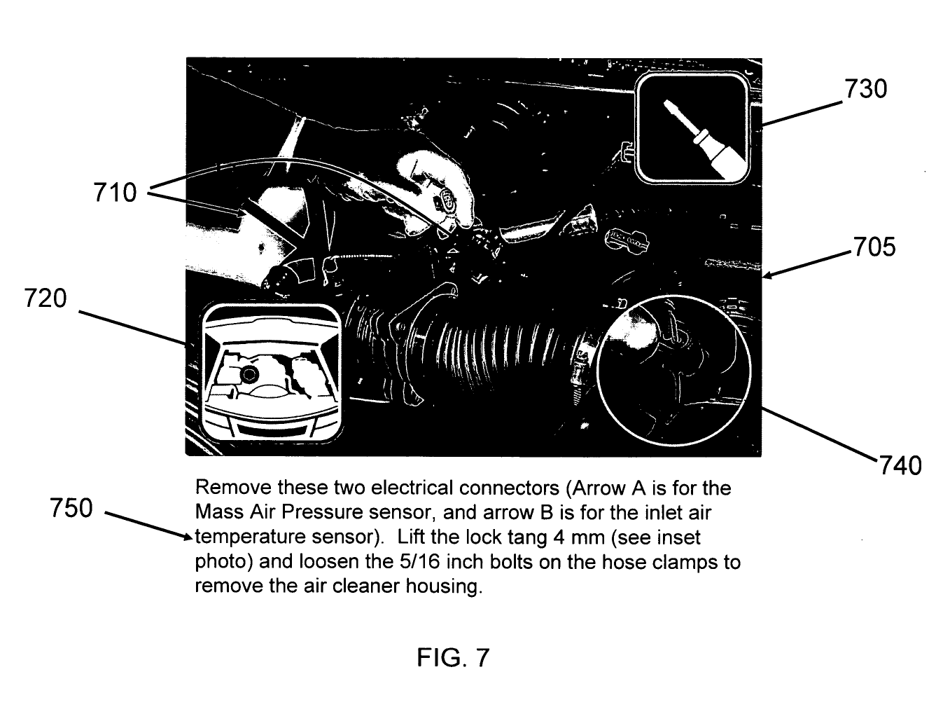

FIG. 7 shows an exemplary instruction activity that uses a nested icon image to aid with the instruction, in accordance with an embodiment of the present invention. FIG. 7 shows an image of the activity to be performed 705. Image 705 may be, for example, a detailed image and/or other multimedia information, such as a close-up and/or evenly lit and/or high depth-of-field color or black- and white photograph or drawing. A minimally descriptive set of instructions 750 for performing the activity shown in image 705, may also be provided. It is noted that in some cases, the set of instructions 750 may or may not be sufficient, by itself, to perform the activity shown in image 705. Also shown in FIG. 7 is a work location icon image, 720, nested within image 705, which shows the location of the activity to be performed within the larger context of the entire product (in this example, a motor vehicle). Tool icon image 730, shows the type of tool(s) to be used when performing the activity shown in image 705. Detail arrows or other indicators 710 may point to a specific area(s) on which a user may need to focus, and a detail, e.g., enlarged, image, 740 may indicate a close-up of the activity to be performed, including part of the activity and/or a specific part or area that might be helpful to focus the user's attention. Images, e.g., icons, photographs or drawings, 710, 720, 730 and 740 may be disposed within the perimeter of image 705 (as shown in FIG. 7), outside of the perimeter of image 705 (not shown), or in a specific area for helpful images

Thus, as shown in FIG. 7, a user may be assisted, via icons 710, 720, 730, and 740, in performing the activity shown in image 705 and described in the set of instructions 750, e.g., removing the air cleaner housing, as follows. For example, the user may be assisted, via work location icon 720, in quickly locating the area to be worked on. Further, via tool icon 730, the user may be assisted in determining the type and/or location of the tool to be used. Further, via detail arrows 710, the user is assisted in understanding that electrical connectors A and B should be removed. In addition, via detail image 740, the user may be assisted in understanding that the lock tang should be lifted 4 mm and the 5/16-inch bolts on the hose clamps need only be loosened, not removed, to remove the air cleaner housing.

Example embodiments of the present invention have now been described in accordance with the above advantages. It will be appreciated that these examples are merely illustrative of the invention. Many variations and modifications will be apparent to those skilled in the art.

1. A method of providing an instructional sequence for a process, the method comprising:
receiving a delineation of the process into a plurality of sequential discrete steps;
receiving multimedia information for each of the plurality of sequential discrete steps;
receiving a title for each of the plurality of sequential discrete steps;
receiving a description of one or more tools needed to perform each of the plurality of sequential discrete steps;
receiving a description of a location for performing each of the plurality of sequential discrete steps;
receiving a description of each of the plurality of sequential discrete steps; and
for each of the plurality of sequential discrete steps, receiving instructions for assembly of the multimedia information, title, description of one or more tools, and description of a location, into a composite presentation.

2. The method of claim 1, further comprising:
providing a multimedia description for each of the plurality of sequential discrete steps, the multimedia description combining the multimedia information, the title, the description of one or more tools, the description of the location, and the description of each of the plurality of sequential discrete steps.

3. The method of claim 2, further comprising:
assembling the multimedia description for all of the plurality of sequential discrete steps into a multimedia instructional template.

4. The method of claim 1, further comprising:
receiving a description of a helpful hint for at least one of the plurality of sequential discrete steps.

5. The method of claim 1, wherein the multimedia information is a photograph.

6. The method of claim 1, wherein the description of one or more tools is a tool icon.

7. The method of claim 1, wherein the description of each of the plurality of sequential discrete steps is subdivided into three steps or less.

8. The method of claim 1, wherein the description of the location is visual information.

9. The method of claim 8, wherein the visual information is an icon.

10. The method of claim 3, wherein the assembled multimedia description is in a published media format.

11. The method of claim 3, wherein the assembled multimedia description is a CD-ROM.

12. The method of claim 3, wherein the assembled multimedia description is a flip book.

13. A system for providing an instructional sequence for a process, the system comprising:
a processor;
a user interface functioning via the processor; and
a repository accessible via the processor;
wherein a delineation of the process into a plurality of sequential discrete steps is received;
wherein multimedia information for each of the plurality of sequential discrete steps is received;
wherein a title for each of the plurality of sequential discrete steps is received;
wherein a description of one or more tools needed to perform each of the plurality of sequential discrete steps is received;
wherein a description of a location for performing each of the plurality of sequential discrete steps is received;
wherein a description of each of the plurality of sequential discrete steps is received; and
wherein, for each of the plurality of sequential discrete steps, instructions are received for assembly of the multimedia information, title, description of one or more tools, and description of a location, into a composite presentation.

14. The system according to claim 13, wherein the processor is housed on a terminal.

15. The system according to claim 14, wherein the terminal is selected from a group consisting of a personal computer, a minicomputer, a main frame computer, a microcomputer, a hand held device, and a telephonic device.

16. The system according to claim 13, wherein the processor is housed on a server.

17. The system according to claim 16, wherein the server is selected from a group consisting of a personal computer, a minicomputer, a microcomputer, and a mainframe computer.

18. The system according to claim 16, wherein the server is coupled to a network.

19. The system according to claim 18, wherein the network is the Internet.

20. The system according to claim 18, wherein the server is coupled to the network via a coupling.

21. The system according to claim 20, wherein the coupling is selected from a group consisting of a wired connection, a wireless connection, and a fiber optic connection.

22. A system of providing an instructional sequence for a process, the system comprising:
means for receiving a delineation of the process into a plurality of sequential discrete steps;
means for receiving multimedia information for each of the plurality of sequential discrete steps;
means for receiving a title for each of the plurality of sequential discrete steps;
means for receiving a description of one or more tools needed to perform each of the plurality of sequential discrete steps;
means for receiving a description of a location for performing each of the plurality of sequential discrete steps;
means for receiving a description of each of the plurality of sequential discrete steps; and
means for receiving, for each of the plurality of sequential discrete steps, instructions for assembly of the multimedia information, title, description of one or more tools, and description of a location, into a composite presentation.

23. A computer program product comprising a computer usable medium having control logic stored therein for causing a computer to provide an instructional sequence for a process, the control logic comprising:
first computer readable program code means for receiving a delineation of the process into a plurality of sequential discrete steps;
second computer readable program code means for receiving multimedia information for each of the plurality of sequential discrete steps;
third computer readable program code means for receiving a title for each of the plurality of sequential discrete steps;
fourth computer readable program code means for receiving a description of one or more tools needed to perform each of the plurality of sequential discrete steps;
fifth computer readable program code means for receiving a description of a location for performing each of the plurality of sequential discrete steps;
sixth computer readable program code means for receiving a description of each of the plurality of sequential discrete steps; and
seventh computer readable program code means for receiving, for each of the plurality of sequential discrete steps, instructions for assembly of the multimedia information, title, description of one or more tools, and description of a location, into a composite presentation.
